(19) United States
(12) Patent Application Publication
(10) Pub. No.: US 2010/0020382 A1
(43) Pub. Date: Jan. 28, 2010

(54) SPACER FOR MEMS DEVICE

(75) Inventors: Yi Fan Su, Hsin Chu County (CN); Yen Hua Lin, Taoyuan Coutny (CN); Feng Ming Pao, Yung-Ho City (CN); Cheng Wei Wu, Chu-Bei City (CN)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/177,816

(22) Filed: Jul. 22, 2008

(51) Int. Cl. G02B 26/00

(52) U.S. Cl. 359/290; 156/60

(57) ABSTRACT

An improved spacer in an apparatus comprising a MEMS device that is packaged between a substrate and cover plate, where the improved spacer protects traces running on the substrate and under the spacer. The improved spacer reduces the amount of force or pressure on the traces or wires, which reduces line out damage when an array of packaged MEMS devices are separated by pressure or force into one packaged MEMS device. In one embodiment, the improved spacer comprises a softer, deformable, elastic, or malleable material that does not crush the traces. This softer material can be an elastic polymeric spacer. In another embodiment, the improved spacer can protect these traces by having a shape with a smaller contact surface which minimizes the amount of traces being affected. This surface can be a sphere or a ball.

### TECHNICAL FIELD

The present invention relates to Microelectromechanical systems (MEMS), an array of interference modulators, and the manufacturing methods thereof and more particularly, to the structure, shape, and composition of an improved spacer.

### DESCRIPTION OF RELATED TECHNOLOGY

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

In the flat panel display industry, MEMS devices may be formed on a substrate and be protected by a cover plate that is attached to the substrate by a rigid sealant. However in many cases there are lead lines which run from the MEMS device, under the sealant, and to external connectors or devices. During an encapsulation or packaging process, the sealant is dispensed on the cover plate and then the sealant is laminated onto the lead lines. A spacer in the sealant is also used to control the gap between the cover plate and the substrate. The rigid spacer damages the wires or lead lines. Also during the separation stage, the cover plate can move downward and damage the lead lines that run under the sealant. In addition, even after separation, a downward force can squish the lead lines between the sealant and the substrate.

### SUMMARY

One embodiment is a method of manufacturing a microelectromechanical systems (MEMS) based display device, the method comprising providing a transparent substrate comprising at least one MEMS device formed thereon, providing a cover plate, and sealing said transparent substrate to said cover plate with a sealant, wherein said sealant comprises a polymeric spacer material.

In another embodiment, there is a microelectromechanical systems (MEMS) based device, comprising a transparent substrate comprising at least one MEMS device formed thereon, and a cover plate sealed to said transparent substrate with a sealant, wherein said sealant comprises a polymeric spacer.

In another embodiment, there is a microelectromechanical systems (MEMS) based device, comprising a transparent substrate comprising at least one MEMS device formed thereon, and a cover plate covering said transparent substrate, and means for sealing said transparent substrate to said cover plate, wherein said sealing means comprises a polymeric spacer material.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a side view illustrating one embodiment of packaged MEMS devices with elastic polymeric spacers.

FIG. 9 is a top view illustrating one embodiment of multiple packaged MEMS devices prior to separation.

FIG. 10 is a side view illustrating one embodiment of packaged MEMS devices with a separation force being applied to separate the devices.

FIG. 11 is a flow diagram illustrating one embodiment of manufacturing packaged MEMS devices with improved elastic polymeric spacers.

### DETAILED DESCRIPTION

One embodiment includes a MEMS device that is formed from sealing a backplate to a substrate, wherein the sealant includes a spacer material. During manufacturing, a plurality of such MEMS devices are made on a single substrate. The individual devices are then separated from one another, by, for example, scribing and breaking. However, the individual devices often contain sensitive wires, leads, or traces that pass under the sealant to communicate data between the MEMS device and external connectors or other electronics. It is unavoidable that these sensitive wires are touched during the MEMS packaging or encapsulation process. During scribing and breaking, the cover plate or fragments of the cover plate may inadvertently touch the wires and leads, which can cause a broken connection or other damage. In addition, the cover plate may apply downward force on the sealant so that the sealant crushes the wires or leads. In one embodiment, a spacer material is incorporated into the sealants, so that when the devices are separated, the wires or leads running under the sealant are protected from damage.

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

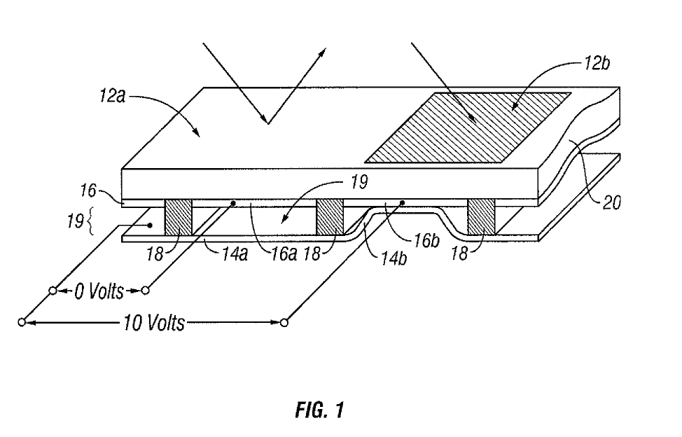

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

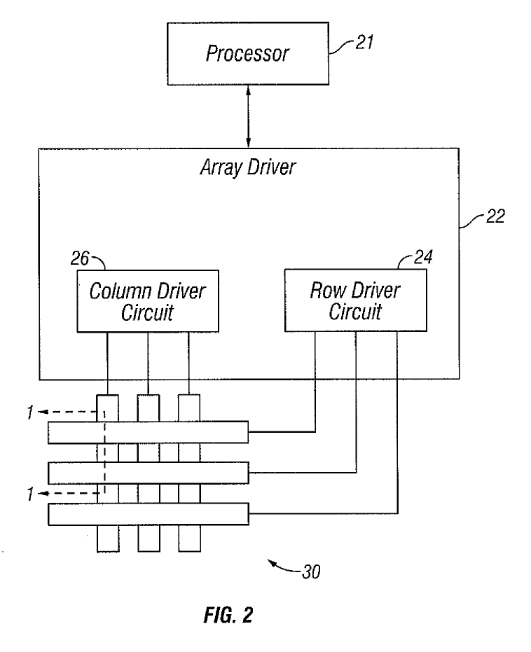

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

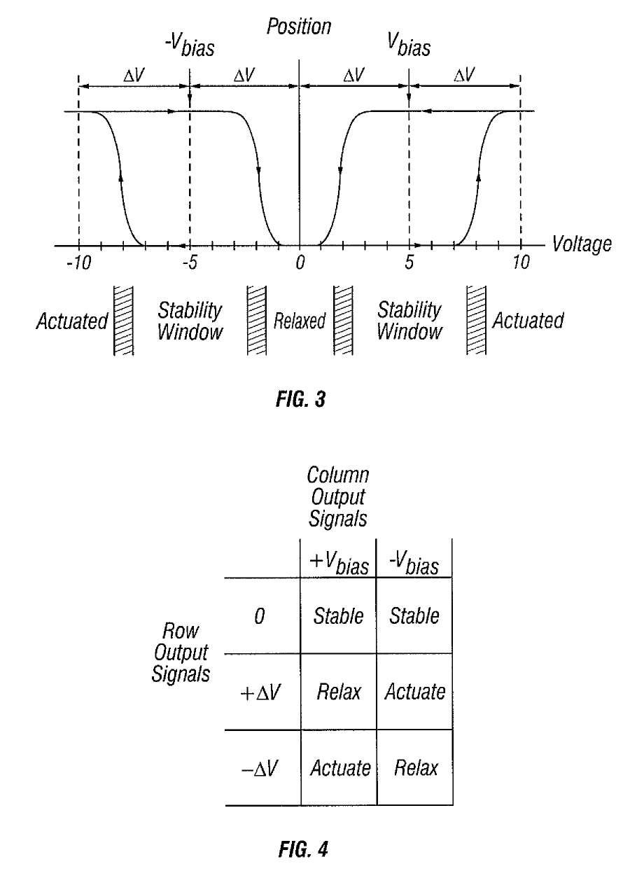

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

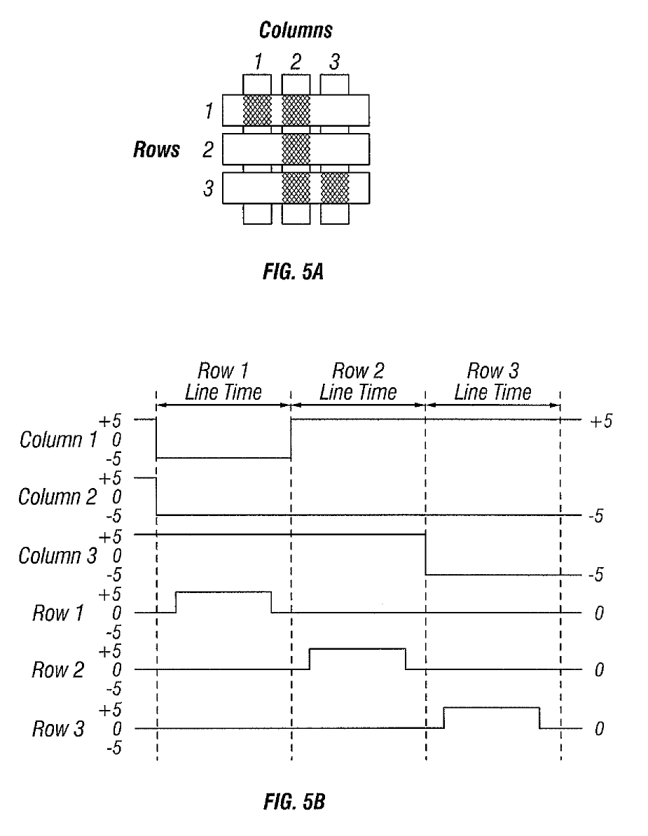

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

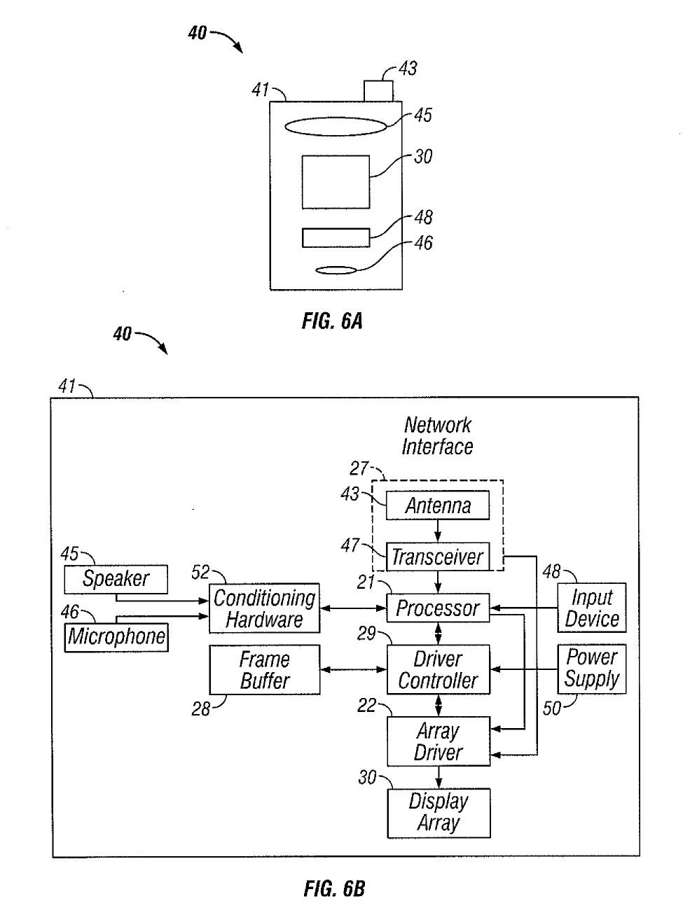

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device,. However, for purposes of describing the present embodiment the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

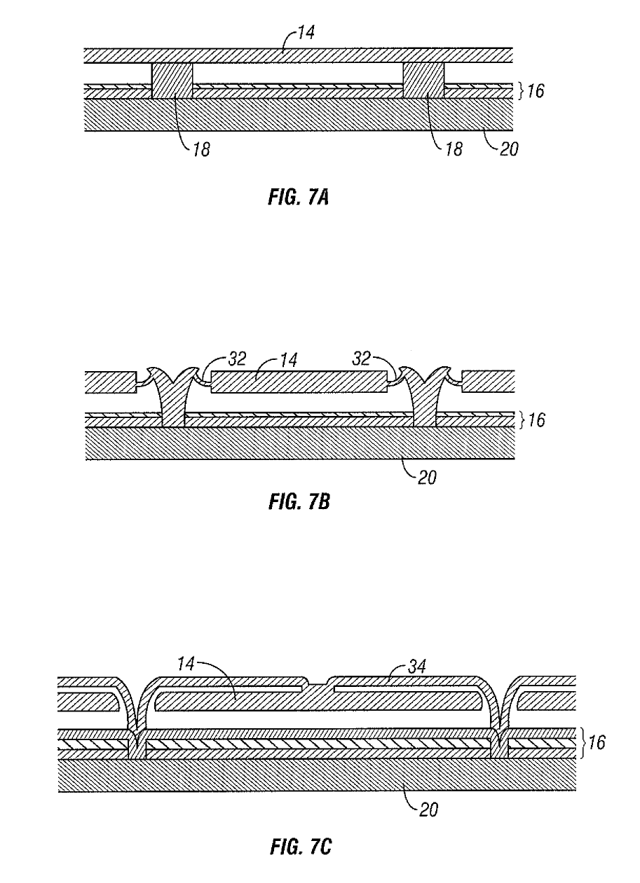

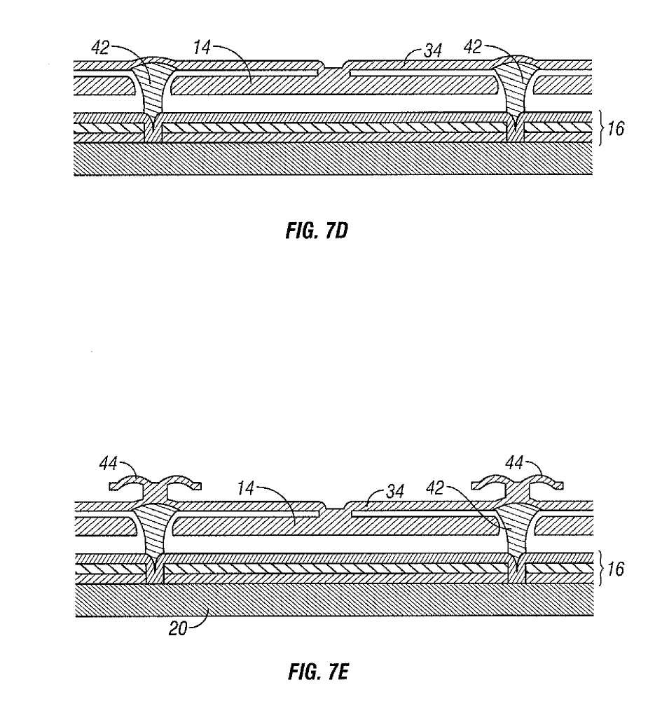

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As discussed above during the manufacturing of a MEMS device, usually multiple MEMS devices are formed on a large substrate, such as glass, and separated later into individually packaged MEMS devices. A separation method is used to separate each of the MEMS devices from each other. In one embodiment, the separation method includes scribing and then breaking or cracking the cover plate and substrate. During the separation method, a significant amount of inward force or pressure may be applied to the cover plate or substrate. This significant force can cause partial or permanent damage to the traces located under sealant. The high likelihood of having damaged traces causes additional manufacturing rework for broken traces and additional quality control checking to catch partially damaged traces.

In one embodiment, a spacer is incorporated into the sealant in order to protect these traces from damage. The spacer can comprises a soft, deformable, elastic, or malleable material that protects the traces from the sharp edges of the cover plate. This soft material can be an elastic polymeric material in one embodiment. In another embodiment, the spacer protects the traces by being in a configuration or shape with a relatively small contact surface which minimizes or eliminates the number of traces being scratched or damaged. Examples of shapes having a relatively small contact surface include a sphere. In another embodiment, the spacer includes a relatively large contact surface to spread out or evenly distribute force or pressure from the cover plate.

Although manufacturing a MEMS device is given as an example where force or pressure can be applied to a packaged MEMS device, force can be applied to a MEMS device after manufacturing as well, such as when the MEMS device is in use. In addition, some embodiments include the spacer being located inside the sealant, however other embodiments wherein the spacer is located in other locations such as being mixed with the sealant or outside of the sealant are also contemplated.

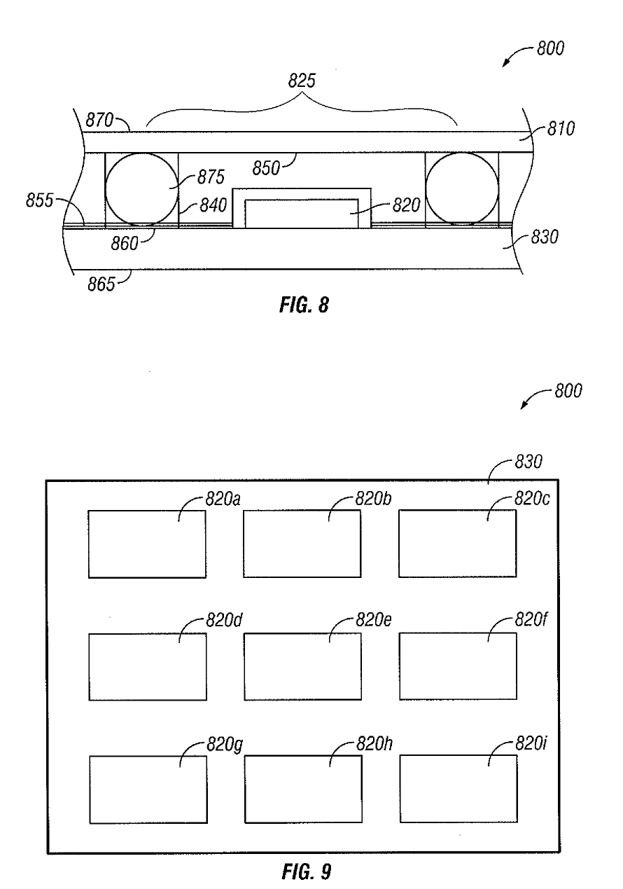

Referring now to FIG. 8, a side view of MEMS device packages 800 is shown with an individual MEMS package 825 that includes a MEMS device 820 packaged using sealant 840. Within the sealant 840 is a polymeric spacer 875. In this embodiment, the MEMS device packages 800 are shown before a manufacturing separation method is used to separate the individual MEMS device package 825 from the rest of the MEMS device packages 800.

As shown, the MEMS device 820 is formed on a transparent substrate 830 and covered by a glass cover plate 810. In one embodiment, the substrate 830 has a plurality of MEMS devices formed thereon, with each device being incorporated into a package. As discussed above in reference to FIGS. 1-7, one type of MEMS device is an interferometric modulator or an interferometric modulator array, which selectively absorbs and/or reflects light using the principles of optical interference. Accordingly, the MEMS device 820 can be an array of interferometric modulators in one embodiment. In another embodiment, the MEMS device 820 can be an array of digital mirrors.

In some embodiments, the substrate 830 or the cover plate 810 can be transparent plastic or glass. Sealant 840 attaches or seals an inside face 850 of the cover plate 810 to an inside face 855 of the substrate 830. The height of the MEMS device package could be measured as the vertical distance from the inside face 850 or 855 to the outside face 870 or 865 of the cover plate 810 or substrate 830, respectively. Thus, sealant 840 provides one means for sealing the transparent substrate 830 to the glass cover plate 810.

In one embodiment, there is at least one spacer 875 located inside the sealant 840. The spacer 875 may control the height and width of a sealant 840, which therefore can control the size of the gap between the substrate 830 and cover plate 810. In another embodiment, the sealant 840 can be a glue or adhesive, and the spacer 875 and sealant 840 can be mixed together to form a spacer-sealant mix. In one embodiment, the spacer 875 is made of an elastic polymeric material such as polyacrylate or polycarbonate. Traces 860 of FIG. 8 are shown running above the substrate 830 and underneath the sealant 840, from the MEMS device 820 to outside connectors or other electronics (not shown).

In one embodiment, the spacer 875 protects the traces 860 by using at least one of a soft, deformable, elastic, and malleable spacer that does not crush traces 860. A deformable material allows the natural form or shape of the material to be marred, pulled out of shape or disfigured. A soft material yields readily to pressure, or changes shape, and is not too hard or stiff. An elastic material is capable of returning to its original height, width, or shape. A malleable material is adaptable and capable of being extended or shaped by pressure.

The Mohs scale of mineral hardness is one of several scientific ways to measure or compare the hardness of a material or mineral. The Mohs scale of mineral hardness characterizes the scratch resistance of a given material through the ability of a harder material to scratch the given material. On the Mohs scale, a glass fiber has a hardness of about 6.5 Mohms, whereas a polymeric spacer can be at least 13 times softer, at about 0.5 Mohms. For reference, a diamond, the hardest known naturally occurring substance, is at the top of the scale at 1500 Mohs. Examples on the opposite end of the scale include a pencil lead, which has a hardness of 1 Mohs (1500 times less than diamond), a fingernail which has hardness 2.5 Mohs, and a knife blade is listed at 5.5 Mohs.

In another embodiment, spacer 875 can protect traces 860 by having a shape with a relatively small contact surface which minimizes the number of traces being in contact with spacer 875. For example, spacer 875 can be spherical. In one embodiment, the spacer is ball shaped with a diameter between 5 and 50 microns. In another embodiment a sealant contains spacer balls which have a 12 micron (i.e., 12 μm) diameter.

In another embodiment (not shown), MEMS device 820 comprises a display that communicates with a processor to process image data, where the processor communicates with a memory device for storing data. This embodiment may also include a driver circuit configured to send at least one signal to the display and a controller configured to send at least a portion of the image data to the driver circuit. This embodiment may also include an image source module configured to send the image data to the processor, where the image source module includes at least one of a receiver, transceiver, and transmitter, and an input device configured to receive input data and to communicate the input data to the processor.

FIG. 9 is a top view of the MEMS devices shown in FIG. 8, illustrating one embodiment of multiple packaged MEMS devices 800 prior to separation. The cover plate 810 (not shown in this figure) has been removed for illustrative purposes, or alternatively is clear, so that the array of MEMS devices 820a-i on the substrate 830 can be seen. While manufacturing, a MEMS device is often packaged with many other MEMS devices before being separated by a separation force.

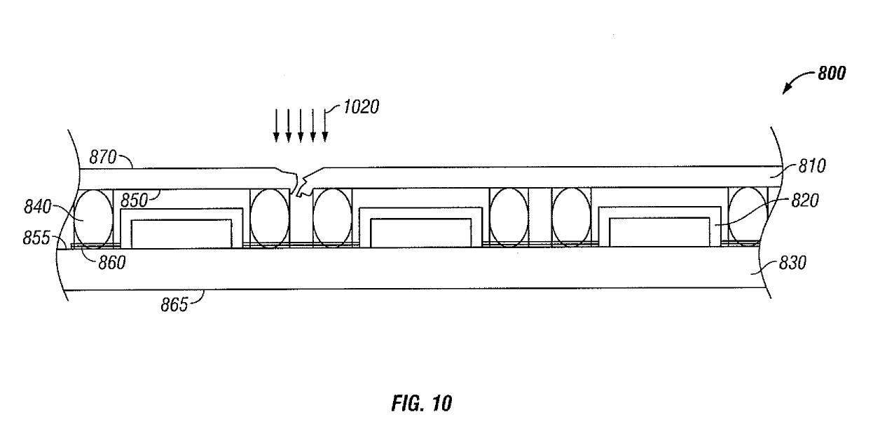

FIG. 10 is a side view illustrating one embodiment of packaged MEMS devices 800 with a separation force or separation apparatus 1020 being applied to the cover plate 810. A separation apparatus often applies inward force on the cover plate 810 or the substrate 830 in order to separate each of the MEMS devices 820. In one embodiment, separation force 1020 is a scribe and break method. As force is applied, the spacer 875 protects the traces 860 from damage.

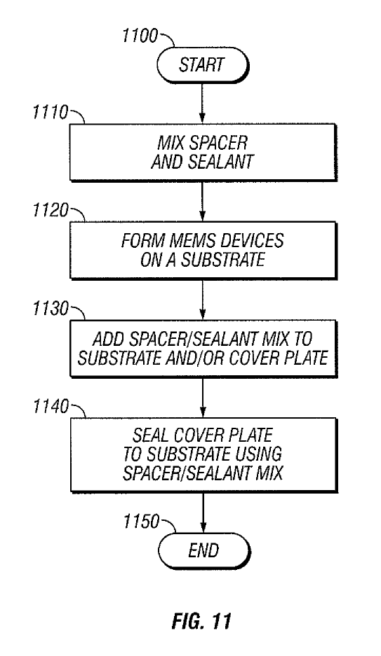

FIG. 11 is a flow diagram illustrating one embodiment of manufacturing packaged MEMS devices with spacers configured to protect traces. In one embodiment, this method takes place in ambient conditions; other embodiments operate in military, commercial, industrial, and extended temperature ranges. The process starts at step 1100. Next, step 1110 mixes a spherical spacer into UV sealant, where extra gas is removed by de-bubbling in a syringe. In one embodiment, the mix comprises between 0.1% and 10% spacer material, and the remaining percentage is a sealant, such as an ultraviolet light curable adhesive. In another embodiment, the mix comprises about 0.5% polymeric spacer material.

Proceeding to step 1120, MEMS devices 820 are formed on substrate 830. At step 1130, the spacer sealant mix is applied to the substrate 830 and/or cover plate 810. In some embodiments, substrate 830 or cover plate 810 can be transparent, larger than about 14 inches by 16 inches, and glass. In one embodiment, the cover plate 810 or substrate 830 is the size of a 10^{th} generation substrate (known as “Gen 10”), which is estimated at 2,850 mm×3,050 mm. Proceeding to step 1140, cover plate 830 is laminated or attached to the substrate 830 via the spacer sealant mix. In some embodiments, cover plate 830 is laminated using UV curing technology, which is a high intensity source of ultraviolet light to initiate a chemical reaction, and can dry and strengthen an attachment. At this point, packaged MEMS devices are formed that protect traces or wires 860 on substrate 830. The process ends at step 1150.

The following experiment demonstrates that use of an adhesive with a spacer material was effective at preventing damage to traces within a MEMS device. The experiment was a test of a glass fiber and a polymer sphere spacer in a UV sealant. The inline yield, damage, and reliability were checked after testing. The parametric test data in the following table showed the lineout yield with an improvement of over 300 times by using the polymer sphere spacer.

| Spacer | Line out yield loss |
|---|---|
| Glass fiber 12 um | 21.68% |
| Polymer sphere 12 um | 0.07% |

Next, the wires were visually inspected. The glass fiber spacer caused visual damage on the wires and lead lines, unlike the polymer sphere spacer. Lastly, reliability was tested. To accomplish this, the size and shape of the sealant was measured over time. Both spacers reliably retained the height and width of the sealant.

Experimental results show that a spherical polymeric spacer, compared to a glass fiber spacer, significantly reduces point scratches, line scratches, scribe defects, and sealant attacks. As a result, without any sacrifices in reliability, a higher yield of successful devices can be built, resulting in less rework and less quality control checking. Spacer 875 provides this protection, while still maintaining a key purpose of a spacer, which is to accurately control the sealant's height and width.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station. In the alternative, the processor and the storage medium may reside as discrete components in a mobile station.

Various modifications to the embodiments described herein may be made, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

What is claimed is:

1. A method of manufacturing a microelectromechanical systems (MEMS) based display device, the method comprising:
providing a transparent substrate comprising at least one MEMS device formed thereon;
providing a cover plate; and
sealing said transparent substrate to said cover plate with a sealant, wherein said sealant comprises a polymeric spacer material.

2. The method of claim 1, wherein the polymeric spacer material is spherical.

3. The method of claim 2, wherein the polymeric spacer material is between 5 and 50 microns in diameter.

4. The method of claim 2, wherein the polymeric spacer material is about 12 microns in diameter.

5. The method of claim 1, wherein the polymeric spacer material is elastically deformable.

6. The method of claim 1, wherein said sealant comprises between 0.1% and 10% polymeric spacer material.

7. The method of claim 1, wherein said sealant comprises 0.5% polymeric spacer material.

8. The method of claim 1, wherein said MEMS device is an interferometric modulator device.

9. The method of claim 1, wherein the method takes place in ambient conditions.

10. A microelectromechanical systems (MEMS) based device, comprising:
a transparent substrate comprising at least one MEMS device formed thereon; and
a cover plate sealed to said transparent substrate with a sealant, wherein said sealant comprises a polymeric spacer.

11. The device of claim 10, wherein the polymeric spacer comprises an elastically deformable material.

12. The device of claim 10, wherein the polymeric spacer comprises a spherical material.

13. The device of claim 12, wherein an end of the polymeric spacer facing the substrate comprises a circular ball shape.

14. The device of claim 10, further comprising:
a display;
a processor that is configured to communicate with the display, the processor being configured to process image data; and
a memory device that is configured to communicate with the processor.

15. The device of claim 14, further comprising a driver circuit configured to send at least one signal to the display.

16. The device of claim 15, further comprising a controller configured to send at least a portion of the image data to the driver circuit.

17. The device of claim 14, further comprising an image source module configured to send the image data to the processor.

18. The device of claim 17, wherein the image source module comprises at least one of a receiver, transceiver, and transmitter.

19. The device of claim 14, further comprising an input device configured to receive input data and to communicate the input data to the processor.

20. A microelectromechanical systems (MEMS) based device, comprising:
a transparent substrate comprising at least one MEMS device formed thereon; and
a cover plate covering said transparent substrate; and
means for sealing said transparent substrate to said cover plate, wherein said sealing means comprises a polymeric spacer material.

21. The device of claim 20, wherein the polymeric spacer material is spherical.

22. The device of claim 20, wherein the polymeric spacer material is elastically deformable.

23. The device of claim 20, wherein the substrate comprises a plurality of MEMS devices formed thereon.

24. The device of claim 23, wherein the MEMS devices comprise an interferometric modulator array or device.

25. The device of claim 20, wherein the substrate and cover plate are at least 2,850 mm×3,050 mm in size.
